(19) United States
(12) Patent Application Publication
(10) Pub. No.: US 2026/0257300 A1
(43) Pub. Date: Sep. 3, 2026

(54) LASER HARDENING INSTALLATION FOR LASER HARDENING A BEARING COMPONENT

(71) Applicant: AKTIEBOLAGET SKF, GOTEBORG (SE)

(72) Inventor: Michael WENDEL, Bremen (DE)

(21) Appl. No.: 19/544,036

(22) Filed: Feb. 19, 2026

(30) Foreign Application Priority Data
Feb. 28, 2025 (DE) 102025107634.0

(51) Int. Cl. B23K 26/352; B23K 26/08; C21D 9/00; C21D 9/36; B23K 103/04; C21D 1/09

(52) U.S. Cl. CPC B23K 26/352; B23K 26/08; C21D 9/0025; C21D 9/36; B23K 2103/04; C21D 1/09; C21D 2211/001

(57) ABSTRACT

A laser hardening installation for laser hardening a bearing component includes a support for supporting the bearing component, at least one laser head and at least one drive apparatus. The laser head is configured to direct a laser beam onto the bearing component to heat a region of the bearing component irradiated by the laser beam to a temperature above an austenitizing temperature of a steel of the bearing component. The drive apparatus is configured to move the bearing component and/or the at least one laser head and/or the laser beam in such a way that the bearing component and the at least one laser head and/or the laser beam move relative to one another, such that different regions of the bearing component are irradiated and heated by the laser beam.

### CROSS-REFERENCE

This application claims priority to German patent application no. 10 2025 107 634.0 filed on Feb. 28, 2025, the contents of which are fully incorporated herein by reference.

### TECHNOLOGICAL FIELD

The present disclosure relates to a laser hardening installation for laser hardening a bearing component.

### BACKGROUND

For the surface hardening of bearing components, use is often made of induction hardening installations which use one or more induction coils to heat an outer layer of the bearing component in portions or in its entirety to a temperature above the austenitizing temperature and then use a quenching apparatus to rapidly cool the outer layer.

The problem with such surface hardening installations, however, is that the complex process control that is required in the combination of heating and quenching can lead to non-uniform hardening results. In addition, the use of type-specific hardening tools can lead to high tool costs and associated minimum batch sizes.

However, other heat treatments known from the prior art such as martensitic hardening, bainitic hardening, case hardening, nitriding or induction hardening have the following disadvantages: batch processes (apart from induction hardening) without single-piece flow; large-scale equipment/furnaces which are required for large rings (which are not readily available); significant warping results in a significant oversize for the soft component and expensive reworking; significant effort for parts handling and logistics; surface damage requires hard machining to remove damaged surfaces (for example decarburization, oxidation, etc.); specific, parts-related tool costs and costs associated therewith (for example inductors for induction hardening); long retooling times when changing production parts; no selective hardening possible (exception: induction hardening); requirement for floor space for heat treatment installations; high energy demand (exception: induction hardening).

### SUMMARY

It is therefore an aspect of the present disclosure to provide a heat treatment installation for hardening bearing components, in particular large bearing components with a closed curve profile, which avoids the above-mentioned disadvantages.

In the following text, a laser hardening installation for laser hardening a bearing component, in particular of a bearing component with closed curve profile, is presented. Such a laser hardening installation is particularly preferred also for bearing components, in particular bearing rings of large rolling bearings, which for example have a diameter of more than 100 cm.

The above-mentioned disadvantages are overcome by the use of laser hardening. Furthermore, the advantages in terms of energy efficiency and handling are evident for large plain bearings with a diameter of more than 100 cm, as will be explained in more detail below.

During laser hardening, the steel components are locally heat-treated in such a way that a martensitic microstructure is generated by rapid laser heating and subsequent cooling by heat conduction. If required for geometric reasons and/or owing to the limited hardenability of the steel used, additional quenching media (for example compressed air or water) may be used in order to increase the quenching speed.

Laser hardening is characterized by requiring limited energy/heat input and thus low energy consumption and associated low CO2 emissions, low warping and limited or no surface oxidation. This affords the possibility of skipping subsequent hard machining steps for removing surface damage, for example oxide layers/decarburized surfaces/scale, that would arise in conventional hardening methods, and of integrating the hardening process into the soft machining. As a result, the lead time and the effort for handling and logistics in the manufacturing chain, in particular for plain bearings with a large diameter, can be reduced.

Furthermore, laser hardening features a high energy density and a short process time. It is also advantageous that only a small volume is affected, or only a small part of the workpiece cross section is treated, and that no process gases are required. As already mentioned above, it is also possible, in the case of laser hardening, to dispense with quenching of the workpiece after heating, since quenching occurs by heat conduction in the component. This has the advantages that no quenching medium and thus also no pumps for quenching or cooling the installation are required. A further advantage of the rapid cooling of the small heated material volume is the possibility of being able to use cost-efficient steels that have a small CO2 footprint, as a result of a relatively only low content of required alloying elements or only a low required hardenability. Furthermore, the same laser source and optics can be used for different workpiece geometries, with the result that it is possible to dispense with or significantly reduce parts-specific tooling.

A further advantage of laser hardening is that, during laser hardening, only very little warping, if any, occurs in the bearing component, with the result that it is possible to partially or entirely dispense with expensive reworking, in particular laborious hard machining. This also has the advantage that a smaller material addition is required since less deformation occurs, this meaning better material utilization and also saving costs.

In addition, the laser hardening process can be integrated into the soft-machining sequence (for example turning, milling, etc.), that is to say into the machining prior to the actual hardening and/or the hard-machining process (for example grinding, honing), that is to say the machining after the hardening, with integration into existing machines even being possible.

In addition, a flexible laser hardening device can be integrated into the soft machining – but also into the hard-machining unit –, and this can reduce the cycle time and significantly increase productivity. This is important particularly in the field of large bearings, where the effort for handling and logistics is comparatively large and expensive.

The laser hardening installation itself further comprises a supporting device which is configured to support the bearing component, at least one laser head which is configured to radiate a laser beam onto the bearing component in such a way that the bearing component is heated above an austenitizing temperature in the region irradiated by the laser beam, and at least one drive apparatus which is configured to move the bearing component and/or the at least one laser head and/or the laser beam. In this case, the bearing component and the at least one laser head and/or the laser beam move relative to one another, such that different regions of the bearing component can be irradiated and heated by the laser beam. The relative movement between the laser head/laser beam and the bearing component makes it possible to ensure that a larger region than that directly irradiated with the laser beam can be heated. This makes it possible for the bearing component to have continuous or discontinuous laser-hardened regions.

With the aid of a continuous laser-hardened region, it is possible for the bearing component to be embodied over its entire circumferential surface without a soft point, ensuring, for example, uniform hardness along the bearing component. Alternatively, it may of course also be advantageous if the bearing component has discontinuous laser-hardened regions.

It is for example possible for a soft, non-laser-hardened region to be provided over the full circumferential surface of the bearing component, or even for a plurality of soft regions to be provided, which form particular patterns. It is for example possible for the hardening to be in the form of a plurality of rectangles/squares, a plurality of circular/oval points, a plurality of triangles, or in the form of zigzag shapes, optionally with different angles.

In this case, the patterns may provide further functions, such as lubricant reservoirs or channels. However, they may also be configured merely as specific designs which, for example, already visually assign the bearing to the applicant as manufacturer.

According to a further advantageous exemplary embodiment, the laser hardening installation further comprises at least one control device which is configured to control the laser head, the drive unit and/or a laser beam deflection device in order to direct the laser beam into the region irradiated by the laser beam.

Laser hardening of the irradiated and thus laser-hardened region also makes it possible for wear marks, for example caused by assembly, to be avoided on the laser-hardened surfaces. The laser-hardened surfaces also make it possible to avoid damage caused by wear particles or bearing component damage in the event of creep movements between the bearing component and the surrounding component. Furthermore, the wear in the case of movements between the bearing components and/or between a bearing component and an element receiving the bearing component can be reduced overall on account of the laser-hardened surface region, this increasing the service life of the bearing components and of the bearing overall.

In addition, a microstructural phase change occurs during laser hardening, and this results in a change in the specific volume and a change in the density of the physical phases, for example in the case of the transformation into martensite and/or bainite. Thus, the hardened and transformed surface regions have a greater volume than in the starting phase and result in a micrometre-range elevation of the laser-hardened surfaces. As a result, it is possible in turn for the press fit and/or the friction to be increased, in particular at contact surfaces with surrounding components, for example a shaft or a housing, such that the components are exposed to less in the way of creep movements.

Furthermore, “craters” can be generated in the surface topography by local melting of the material and evaporation of the melt (laser engraving). The increased specific volume of the martensitic outer layer furthermore generates residual compressive stresses in the outer zone, which counteract crack initiation and crack propagation.

The increase in the coefficient of friction can also make it possible, however, for the press fit or the force fit itself to be reduced, since the high coefficient of friction ensures an equally good form fit between the components. A lower press fit or a smaller contribution of the force fit in turn results in lower tensile stresses in the bearing component (for example inner ring shrink-fitted onto a shaft), this in turn resulting in a longer component service life.

Furthermore, an increased coefficient of friction between the bearing component and the surroundings (for example housing/shaft) caused by the texturing of the surface can contribute to the avoidance of movements (for example ring creep), as a result of which the service life of the bearing component can be extended.

According to a further advantageous exemplary embodiment, the laser head is configured to generate a laser beam which heats a strip-shaped region, wherein preferably a diode laser is used. This makes it possible already for not only a punctiform region but also a spatially extended region on the bearing component to be hardened, in particular surface-hardened, by the laser.

Furthermore, it is advantageous if not only one laser head is provided, but rather a plurality of laser heads are provided, which are arranged in such a way that the regions irradiated by the laser beams of the laser heads are directly adjacent to one another. The laser heads may be arranged next to one another and/or one above the other. If the irradiated regions are directly adjacent to one another, the bearing component can be hardened in a slip-free manner.

Furthermore, the laser heads may also be formed in such a way that at least one of the laser heads is configured to be movable and at least one other of the plurality of laser heads is stationarily arranged in the laser hardening installation.

In order to meet specific requirements, that is to say for example to harden a region more deeply or more intensively than a directly bordering region or to specifically provide a soft point, that is to say a region that has been heated, cooled and then heated again, it may alternatively be desirable for the regions irradiated by the laser heads to at least partially overlap. In this case, the overlap may also be in the form of a spatial and/or temporal overlap. In the overlapped regions, a particularly intensive irradiation can then be achieved, which can be used, for example, for deeper hardening or a higher hardness, and/or the region is heated again after cooling.

According to a further advantageous exemplary embodiment, the plurality of laser heads are arranged uniformly around the bearing component. As a result, equally dimensioned regions to be irradiated can be covered with the laser heads, in particular in the case of large bearing components.

According to a further preferred exemplary embodiment, the different regions irradiated by the laser beam or the laser beams continuously merge into one another. This allows even large bearing components to be uniformly surface-hardened.

Alternatively or additionally, the regions irradiated by the laser head or the laser heads may be distributed discontinuously over the bearing component. This is particularly advantageous if surfaces which are in contact with a surrounding component are hardened and for example the friction is intended to be increased, or if, for example, particular contours which are intended to fulfil particular functions, such as, for example, are in the form of a lubricant reservoir, are intended to be formed on the surface to be hardened.

As bearing component, rolling bearing and/or plain bearing components can be laser-hardened. The at least one laser head may be arranged in such a way that it irradiates one or more functional or non-functional surfaces of the bearing component. In this context, a functional surface is understood to mean surfaces that are exposed to either a rolling contact or a sliding contact. By contrast, non-functional surfaces are defined as those surfaces that for example come into abutment with a component receiving the bearing component but do not assume a bearing function. These include, for example, flanges, sealing lip run-on surfaces, an outer surface of an outer ring that is contacted by a housing, and/or an inner surface/bore of an inner ring that is in contact with a shaft.

In rolling bearings, it is for example possible for the at least one laser head of the laser hardening installation to be arranged in such a way that a raceway is hardened as a functional surface. In this case, the region irradiated by the laser beam is preferably irradiated so intensively/long that a hardness penetration depth achieved by the heating and a strength level that can be achieved with the laser hardening is sufficient to sufficiently cover a Hertzian stress produced by the rolling of the rolling elements over the raceway.

In plain bearings, a contact surface of a sliding pair can be hardened as a functional surface by means of the at least one laser head. Preferably, the laser-hardened region extends over the entire contact surface of the sliding pair. However, the hardness depth may gradually decrease in an outer region of the region to be hardened as long as the required surface hardness is achieved over the sliding contact.

Preferably, the irradiation by means of the at least one laser head is controlled in such a way that the surface hardness of a raceway of an inner or outer ring of a rolling bearing or of an inner or outer ring in the sliding contact is at least equal to or higher than the other raceway or that of the sliding partner.

As an alternative or in addition to the laser hardening of the functional surfaces, it may also be advantageous in the case of non-functional surfaces to harden these with the aid of one or more laser heads arranged on the bearing component, in order to for example protect the non-functional surfaces particularly against wear.

As mentioned above, the non-functional surface may be, in particular, an inner diameter surface of an inner ring, an outer diameter surface of an outer ring, a side surface of a bearing ring, and/or a flange of a bearing ring.

According to a further advantageous exemplary embodiment, the at least one control device is configured to control the laser head, a laser beam deflection device and/or the drive apparatus in such a way that the irradiated and thus laser-hardened region has a first and at least a second surface region, wherein the first is laser-hardened to a first hardness depth and the second surface region is laser-hardened to a second hardness depth, wherein the second hardness depth is lower than the first hardness depth. The control device, which may be referred to as a “controller,” may include a programmable hardware component such as and/or including a processor, a computer processor (CPU = central processing unit), an application-specific integrated circuit (ASIC), an integrated circuit (IC), a computer, a system-on-a-chip (SOC), a programmable logic element, or a field programmable gate array (FGPA) including a microprocessor.

Alternatively or additionally, the control device may also be designed such that the bearing component has at least a third surface region that is not laser-hardened.

As mentioned above, a microstructural phase change occurs during laser hardening, and this results in a change in the specific volume and a change in the density of the physical phases, for example in the case of the transformation into martensite and/or bainite. The hardened and transformed regions have a greater volume than in the starting phase and result in a micrometre-range elevation of the laser-hardened surfaces.

Here, “more deeply” hardened surface regions are elevated higher than less “deeply” hardened surface regions or surface regions that have not been hardened at all. In other words, the first surface region is elevated higher than the second surface region and the third surface region. Likewise, however, the second surface region is also elevated higher than the third surface region.

As a result, a particular surface texture and topology can be applied to the bearing component with the aid of the laser hardening installation. Alternatively, as a result of sufficient heating and the generation of local melt pools, it is also possible for material to be removed/evaporated and for a texture to be generated as a result (laser engraving).

Of course, the laser hardening installation may also be configured to irradiate and heat further surface regions, such that laser-hardened regions with further different hardness depths are provided, in order, for example, to further refine the surface texture.

Thus, as disclosed by a further preferred exemplary embodiment, the laser hardening installation and in particular the at least one control device may be designed in such a way that the first and the second and/or third surface region are arranged in such a way that the second and/or third surface region forms a lubricant reservoir and/or a lubricant channel, which is delimited by the first surface region. This advantageously contributes to a reduction in wear at contact points with other components, in particular sliding contacts. In addition, it is therefore possible to ensure that lubricant can be held at particular points on the bearing component, in particular at particular points on the irradiated regions, and/or can be guided to particular points in the bearing component, in particular to particular points on the raceways and/or sliding surfaces.

It is thus possible to generate, for example, a "golf ball topography" in order to create lubricating channels and thus improve the lubricating conditions. As mentioned above, this can be achieved either by selective hardening of local regions or by a different hardness depth, or by melting. The resulting recesses act as lubricant reservoirs.

This behaviour or this property can also be used to generate textures for increased friction on non-functional contact surfaces, in order, for example, to avoid a relative movement between rings and contact partners (housing/shaft). As a result of a form fit or a friction fit with a very high coefficient of friction, which impedes the relative movement of bearing and counterpart in use, a lower press fit/a smaller contribution of the force fit can be achieved, this in turn resulting in lower tensile stresses in the bearing component (for example inner ring shrink-fitted onto a shaft) and a longer component service life.

Therefore, an exemplary embodiment in which the region irradiated by the laser beam is a non-functional surface and has a first surface region, which has a first hardness depth and thus a first coefficient of friction, and a second surface region, which has a second lower hardness depth and thus a second coefficient of friction, and/or which has a non-laser-hardened third surface region with a third coefficient of friction, wherein the first coefficient of friction is higher than the second and/or third coefficient of friction, is also advantageous.

As a result of the specific increase in the coefficient of friction of the bearing component at particular points with the aid of the irradiation by means of the laser hardening installation, the relative movement between the bearing component and a counterpart (for example a shaft/housing) in use can be made more difficult. The increase in the coefficient of friction and also the particular configuration of the surface texture can allow a lower press fit or a smaller contribution of the force fit, this in turn resulting in lower tensile stresses in the bearing component and a longer component service life.

According to a further preferred exemplary embodiment, the laser hardening installation is configured to irradiate the bearing component in such a way that at least one soft point or soft seam is present on the bearing component in the region of the irradiated region, wherein the soft point/soft seam is arranged in a non-loaded region of the laser-hardened region, and/or wherein the soft point/soft seam is arranged at an angle to a loading direction of a load acting on the bearing component, for example by rolling of rolling elements over a raceway.

There may be one soft point/soft seam or a plurality of soft points/soft seams.

Such a soft point/soft seam may also be produced, for example, by the laser hardening installation being configured to heat an already hardened region again. This may be effected, for example, by the laser beam that irradiates the surface to be hardened passing again over regions of the surface to be hardened that have already been heated and cooled down. Such soft points are not necessarily critical, in particular in the case of plain bearings, since the entire surface serves as a sliding surface and local small-scale soft points are not critical if the sliding surface is otherwise hardened.

As a result, the hardening method and in particular the laser hardening installation can be significantly simplified, since it is possible to dispense with complex installation technology or process control, in particular also for preheating, or the like, which would be necessary for slip-free hardening, that is to say hardening without a soft point or soft seam.

In principle, the surface region to be hardened can be hardened by means of laser hardening with a soft seam or without a soft seam.

If possible, the technically simpler method, the hardening method with a soft seam for the hardening of a raceway/sliding surface, should be preferred. In particular, if permanent contact of the sliding elements can be avoided (for example in the case of hydrodynamic or hydrostatic plain bearings), a soft seam can be accepted.

All non-functional surfaces can be hardened with a soft seam. The soft point or soft seam is preferably oriented in the axial direction or perpendicularly to the rolling-over/loading direction. In order to achieve a better load and stress distribution, it is possible, as disclosed by a further preferred exemplary embodiment, for the soft seam to be embodied at a different angle than parallel to the axial direction of the ring.

If the plain bearing or rolling bearing (pivot bearing) executes an oscillating movement of less than 360°, typically +/- 5° - 40°, the soft seam can also be positioned in the non-loaded zone.

According to a further preferred exemplary embodiment, the plain bearing has a bearing ring split at at least one separation surface, wherein at least one soft point is provided preferably next to the separation surface. The laser beam hardening device can also be used in order to generate, at the separation point, a local groove for crack initiation for the subsequent, deliberate separation (laser notching).

If one of the plain bearing rings is split for assembly reasons, laser hardening is particularly advantageous, since the volume into which internal stresses are introduced by the laser hardening is much smaller than in the case of conventional hardening, this resulting in less deformation when the bearing rings are separated. The deformation during separation arises as a result of the releasing of the internal stresses that are introduced into the bearing ring during heating/hardening. In particular in the case of inductive hardening, the internal stresses may be so great that laborious reworking is required after separation, or, in the worst case, the bearing ring as a whole is unusable.

Furthermore, it is advantageous if the bearing ring to be separated has a soft seam next to the separation surface. This can be arranged next to the split, which is located outside the loaded zone. As a result, the deformation brought about during the releasing of the internal stresses caused by the separation can be counteracted particularly well, since no internal stresses or only insignificant internal stresses have been introduced in the region of the soft seam.

According to a further advantageous exemplary embodiment, the laser hardening installation has at least one drive apparatus which is in the form of a bearing component rotation apparatus, and is configured to rotate the bearing component. In such a laser hardening installation, the bearing component is rotated past at least one fixed laser head. This has the advantage that the laser beam of at least one laser head does not have to be deflected into various regions during the heating operation, ensuring particularly uniform heating. In addition, the bearing component can be moved more easily, since no power supply lines, as required for the laser head, or similar, need to be carried along during a rotation or movement of the bearing component.

Furthermore, it is advantageous if the supporting apparatus is in the form of at least three discrete support units, and wherein at least one of the support units has the drive unit. This makes it possible to provide a readily accessible supporting apparatus that can at the same time be flexibly adapted to different bearing components.

Furthermore, it is advantageous if the laser hardening installation has, at at least one of the support units, a preferably interchangeable support element which is configured to contact the bearing component at the predefined position and to rotatably mount it. The interchangeability of the support element allows adaptation to different geometries of the bearing component to be mounted. It is for example possible for the interchangeable support element to have a cylindrical, conical or toroidal outer contour in dependence on the shape and design of the bearing component to be mounted.

In particular, it is advantageous if at least one of the support units has a cylinder which can be rotated about its longitudinal axis, such that the bearing component itself can be moved via the support units.

The axial rotatable cylinder thus ensures a planar support surface and at the same time, due to its rotation capability, easy and low-friction moving of the bearing component over the cylinder. In addition, the plurality of support units make it possible to ensure that the bearing component is mounted in a tilt-free manner and the position of the component does not shift during rotation.

In this case, it is particularly preferred if the rotatable cylinder is in the form of a drive unit, and is configured to move the supported bearing component, in particular to set it in rotation. This makes it possible to provide a drive unit which moves the bearing component easily and cost-effectively. In addition, since only the bearing component and not the entire laser hardening installation including the laser head has to be set in motion, a significant weight reduction of the parts to be set in motion can be achieved, even in the case of large bearing components. This in turn also allows, in addition to the lower loading of the components and thus also less wear on the components of the drive system, a more precise adjustment of the process parameters, such as the relative speed, and thus an improved heat input into the bearing component. Furthermore, less energy needs to be used in order to set the bearing component in rotation than in the case of conventional systems, such that a cost reduction is also possible as a result.

According to a preferred exemplary embodiment, a spatial location of the interchangeable support element, in particular a radial distance of the interchangeable support element from a centre of the laser hardening installation, can be adjusted as desired. This makes it possible for bearing components of different shapes and sizes, in particular with different diameters, to be received in the laser hardening installation.

Furthermore, it is preferred for the interchangeable support element to be in the form of a sleeve which is configured to be displaceable. This makes it possible to provide a workpiece receiving apparatus which is particularly easy to adapt.

In order to allow tilt-free mounting of a component bearing, it is furthermore advantageous if the at least three support surfaces comprise three rod-shaped carriers, each spaced apart from one another at an angle of about 120°. Alternatively, four rod-shaped carriers may preferably also be present, wherein the four rod-shaped carriers are arranged distributed in an X arrangement.

According to a further preferred exemplary embodiment, the drive unit is in the form of a rotatable friction wheel or friction roller which bears against the bearing component and frictionally interacts with the bearing component in order to rotate it. This makes it possible to create a particularly cost-effective drive unit.

Furthermore, it is advantageous if a weight force applied by the bearing component to the support unit determines a friction force between the support unit and the bearing component. This allows the design of a friction roller, even if no specifically designed friction surface additionally increases the friction force. The weight force alone may be sufficient, in particular in the case of large and heavy bearing components, so that the support unit can set the bearing component in rotation.

Of course, it is however also possible for the support unit to have a friction lining which increases a friction force between the support unit and the bearing component. The friction lining may be produced from an elastomeric material or rubber material, which applies a significant friction force to the bearing component and also can, in particular due to its elasticity and low hardness, mount the bearing component in a damage-free manner.

It is also possible, in the case of a plurality of support units equipped with an interchangeable support element, for the interchangeable support elements to be able to be configured differently, for example only one of the interchangeable support elements may have an elastomeric friction lining, while the other may not have a friction lining or may have a different friction lining.

It is furthermore advantageous if a measuring apparatus, for example a pressure sensor, which determines the weight force is provided on the drive unit. An embodiment in which, based on the measured weight force or a determined friction force, which can also be made up of weight force and/or coefficient of friction of the friction roller, a control unit can control the drive unit in such a way that the weight force and/or the friction force is optimized is also advantageous. This makes it possible to ensure that, even in the case of structural non-uniformities, such as imbalance, the bearing component is nevertheless driven with a constant force and uniform heating can be achieved. Damage due to excessive action of force on the bearing component is also avoided.

Furthermore, the determination/adjustment of the friction force can also ensure that slip between the bearing component and the drive unit is minimized. In addition, the defined friction force allows a precise adjustment of the movement speed, in particular it is possible to allow the bearing component to rotate at a defined speed.

According to a further preferred exemplary embodiment, the axis of rotation of the at least one support unit, or of the at least one interchangeable support element, is formed perpendicularly to an axis of rotation of the bearing component. This makes it possible to exert a tangentially oriented movement impulse from the support unit/the interchangeable support element to the bearing component, which is suitable for setting the bearing component in motion and in rotation.

Furthermore, it is advantageous if each support unit has an interchangeable support element on which the bearing component rests. This makes it possible to ensure that the bearing component is moved with particularly low friction in the laser hardening installation. In this case, it is also possible for only one of the interchangeable support elements to be in the form of a drive unit and be actively driven, while the other interchangeable support elements are not in the form of a drive unit and can be set in rotation passively, via the movement of the bearing component. This allows energy-saving driving and at the same time also a simple construction in terms of control technology, since only one drive unit is present. If there are a plurality of drive units, it is necessary to ensure that these rotate at the same speed in order to ensure a uniform drive movement. This in turn requires a more complex control means (control device) than if only one interchangeable support element functions as a drive unit.

According to a further preferred exemplary embodiment, at least one rotation speed measuring unit is furthermore provided, which determines a rotation speed of the bearing component. It is particularly advantageous if the rotation speed measuring unit determines a rotation speed of the support unit or of the driven interchangeable support element. This makes it possible to ensure that the bearing component is moved past the at least one laser head at a constant and determined speed.

Preferably, a further rotation speed measuring unit may be provided on one of the passive rotating interchangeable support elements, which determines a rotation speed of the passively driven interchangeable support elements, wherein a control unit is furthermore provided, which is configured to determine a slip of the bearing component from a rotation speed difference between the active and passively driven interchangeable support elements. In addition to the weight force determination described above, it is also possible to use the rotation speed measurement to determine whether a sufficient friction force of the driven interchangeable support element is provided. This also makes it possible to ensure the uniformity of the rotation along the at least one laser head.

In particular, it is advantageous if the control unit is furthermore configured to increase the friction force when a predetermined rotation speed difference is exceeded, and/or to output a notification about increased slip.

According to a further preferred exemplary embodiment, at least one drive apparatus is in the form of a laser head movement apparatus which is configured to move the laser head along the bearing component. Particularly in the case of very large bearing components, it may be possible that these can no longer be moved with a drive apparatus, as described above due to the significant weight force. It may also be more economical, in the case of smaller bearing components, to move the at least one laser head along the bearing component than to provide an additional installation that moves the corresponding bearing component itself.

Since laser head power supply devices, in particular, for example, power cables, also have to be moved together with the laser head, it is furthermore advantageous if the laser hardening installation has not only one but at least a first and a second laser head, which are respectively movable by means of a first and a second laser head movement apparatus, wherein the laser head movement apparatuses are configured to move the first and the second laser head in opposite directions to one another from a start position to an end position along the bearing component, wherein preferably the first laser head is movable clockwise and the second laser head is movable anticlockwise along the bearing component. As a result, the laser heads and the associated laser head power supply devices have to be moved and tracked only through 180° or less along the bearing component, allowing a simplified laser hardening installation construction.

In order to nevertheless carry out hardening in a slip-free manner, that is to say without soft points, it is furthermore advantageous if the first and the second laser head in the start position are arranged directly next to one another in a start zone, such that the regions irradiated by the laser beams of the first and second laser head are directly adjacent to one another in the start zone, and/or wherein the first and the second laser head in the end position are arranged directly next to one another in an end zone, such that the regions irradiated by the laser beams of the first and second laser head are directly adjacent to one another in the end zone.

Since, however, slip sometimes cannot be avoided in the start zone and end zone even in the case of regions irradiated with a laser beam which are directly adjacent to one another, a further exemplary embodiment in which a third and/or a fourth laser head, which are designed as pre-heating laser heads, are provided, which are respectively movable by means of a third and/or a fourth laser head movement apparatus, wherein the third and/or fourth laser head movement apparatuses are configured to move the third and fourth laser head in such a way that a region in the start zone and/or end zone can be heated is advantageous. This also makes it possible to ensure in the start zone and end zone that uniform hardness is obtained on the bearing component.

The laser head movement apparatus may be in the form of a physical movement apparatus that moves the entire laser head, but it is also possible for in particular the third and/or fourth laser head movement apparatus to be in the form of a laser beam deflection apparatus. Since here only a small region of the start and end zone is irradiated, a laser beam deflection apparatus is sufficient to heat the entire start and end zone.

Particularly in the case of small bearing components or in the case of a correspondingly large number of laser heads distributed on the bearing component, it is also possible overall merely with the aid of the respective laser beam deflection apparatuses to ensure that the laser beams irradiate and heat the corresponding regions on the bearing component.

Further advantages and advantageous embodiments are specified in the description, the drawings and the claims. In particular the combinations of the features specified in the description and in the drawings are purely illustrative here, and therefore the features can also be present individually or in other combinations.

### BRIEF DESCRIPTION OF THE DRAWINGS

The disclosure will be described in more detail hereinafter with reference to exemplary embodiments illustrated in the drawings. The exemplary embodiments and the combinations shown in the exemplary embodiments are purely illustrative and are not intended to define the scope of protection of the disclosure which is defined solely by the appended claims.

FIG. 1 is a schematic plan view of a laser hardening installation according to an embodiment of the present disclosure.

FIG. 2A is a schematic plan view of a first bearing component being irradiated by a first laser.

FIG. 2B is a side view of the first bearing component of FIG. 2A showing a region of the first bearing component that has been irradiated by the laser of FIG. 2A.

FIG. 3A is a schematic plan view of a second bearing component being irradiated by second lasers.

FIG. 3B is a side view of the first bearing component of FIG. 3A showing a region of the second bearing component that has been irradiated by the lasers of FIG. 3A.

FIG. 4A is a schematic plan view of a third bearing component being irradiated by third lasers.

FIG. 4B is a side view of the third bearing component of FIG. 4A showing regions of the third bearing component that have been irradiated by the lasers of FIG. 4A.

FIG. 5A is a schematic plan view of a fourth bearing component being irradiated by a fourth laser.

FIG. 5B is a side view of the fourth bearing component of FIG. 5A showing a region of the fourth bearing component that has been irradiated by the laser of FIG. 5A.

FIG. 6A is a schematic plan view of a fifth bearing component being irradiated by fifth lasers.

FIG. 6B is a side view of the fifth bearing component of FIG. 6A showing regions of the fifth bearing component that have been irradiated by the lasers of FIG. 6A.

FIG. 7A is a schematic plan view of a sixth bearing component being irradiated by a sixth lasers.

FIG. 7B is a side view of the sixth bearing component of FIG. 7A showing regions of the sixth bearing component that have been irradiated by the lasers of FIG. 7A.

FIG. 8 is a perspective view of a first exemplary embodiment of a laser-hardened bearing ring.

FIG. 9 is a perspective view of a second exemplary embodiment of a laser-hardened bearing ring.

FIG. 10 is a perspective view of a third exemplary embodiment of a laser-hardened bearing ring.

FIG. 11 is a perspective view of a fourth exemplary embodiment of a laser-hardened bearing ring.

### DETAILED DESCRIPTION

Hereinafter, identical or functionally equivalent elements are denoted by the same reference signs.

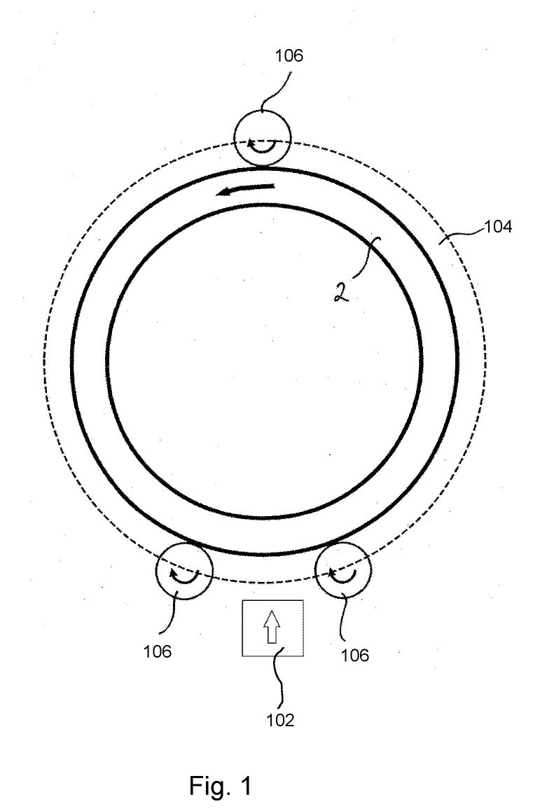

FIG. 1 schematically shows a plan view of a laser hardening installation 100 which is configured to harden a bearing component 2, for example a bearing ring, with the aid of at least one laser head 102. The at least one laser head 102 is configured to irradiate the bearing component 2 with a laser beam in such a way that the bearing component 2 can be heated above an austenitizing temperature in the region irradiated by the laser beam.

During laser hardening, the bearing components are locally heat-treated in such a way that a mainly martensitic microstructure is generated by rapid laser heating and subsequent cooling by heat conduction. If required for geometric reasons and/or owing to the limited hardenability of the steel used, additional quenching media (for example compressed air or water) may be used in order to increase the quenching speed.

Laser hardening features limited energy/heat input and thus low energy consumption and associated low CO2 emissions, low warping and limited or no surface oxidation, and also a high energy density and a short process time.

Here, only a small volume, or only a small part of the workpiece cross section, is treated, with the result that it is possible, in the case of laser hardening, to dispense with quenching of the workpiece after heating, since quenching occurs by heat conduction in the component. This has the advantages that no quenching medium and thus also no pumps for quenching or cooling of the installation are required. Furthermore, the same laser source and optics can be used for different workpiece geometries, with the result that it is possible to dispense with parts-specific tooling.

The laser hardening installation 100 illustrated in FIG. 1 furthermore comprises a supporting apparatus 104 which is configured to support the bearing component 2. The supporting apparatus 104 may be in the form of a table, but it is also possible for the supporting apparatus 104 to be in the form of a separate carrier. The supporting device 104 itself may be configured to be rotatable, or have rotatable elements which are configured to rotate the bearing component 2.

In the exemplary embodiment illustrated in FIG. 1, drive units 106 are provided, which rotate the bearing component 2. As a result, in the laser hardening installation 100, the bearing component 2 is guided past the at least one laser head 102, which is preferably of fixed design, such that at all times only a part of the bearing component 2 is heated.

The drive unit 106 may, for example, be a friction wheel or a friction roller which acts directly on the bearing component 2 and sets it in rotation. In order to ensure that the movement of the bearing component 2 is not impeded or made difficult by friction on the supporting apparatus 104, for example on support units, it is also advantageous to equip the support units with rotatable elements. In this case, the support units may, for example, have rotatable support elements, in particular rotatable sleeves, which provide a good support surface for the bearing component 2 and easy movability of the bearing component 2.

Of course, it is also possible for the laser hardening installation 100 to be configured in such a way that the at least one laser head 102 is moved while the bearing component 2 rests on the supporting apparatus 104. Here, too, only a part of the bearing component 2 is heated.

In other words, the bearing component 2 and the at least one laser head 102 and/or the laser beam move relative to one another, such that different regions of the bearing component 2 can be irradiated and heated by the laser beam. The relative movement between the laser head/laser beam 102 and the bearing component 2 makes it possible to ensure that a larger region than that directly irradiated with the laser beam can be heated. This makes it possible for the bearing component 2 to have continuous or discontinuous laser-hardened regions.

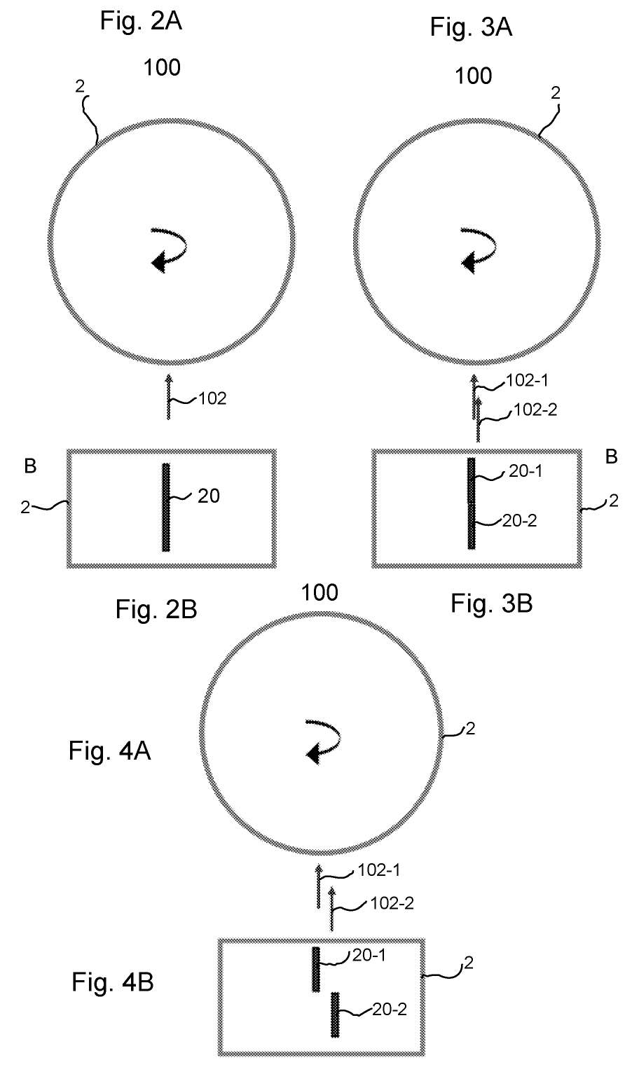

FIGS. 2 to 7 show various basic principles of laser hardening in a non-exhaustive list. Thus, further laser hardening arrangements are possible from the scope of the disclosure.

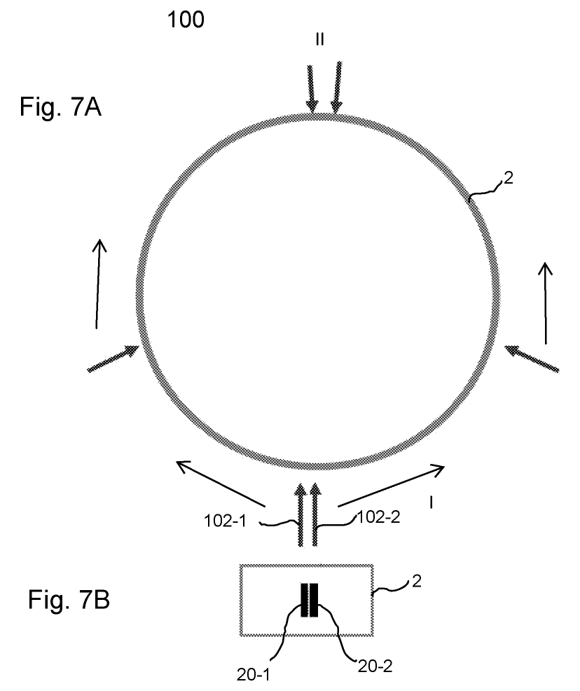

FIGS. 2 to 6 show, like FIG. 1, the principle of a laser hardening installation 100, in which the bearing component 2 is set in rotation with the aid of the drive apparatus 104 and is moved relative to the laser head 102 as a result. FIG. 7, by contrast, shows the other principle of a laser hardening installation 100, in which the at least one laser head 102 is moved along the bearing component 2.

In the schematic illustrations of FIGS. 2A, 2B, 3A, 3B, 4A, 4B, 5A, 5B, 6A, 6B, 7A and 7B, in each case partial view A schematically shows a plan view of the bearing component 2 with laser head/laser heads 102 arranged thereon, while partial view B shows a side view of the bearing component 2, in which an irradiated region 20 is heated with the aid of the at least one laser head.

The laser head 102 may, for example, be in the form of a diode laser which can heat a strip-shaped region, as illustrated in the partial views B.

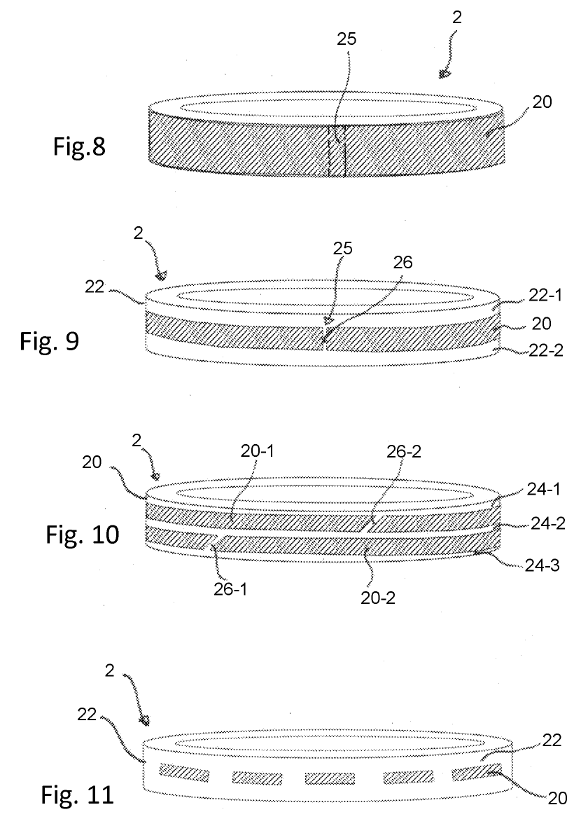

FIGS. 2A and 2B schematically show an exemplary embodiment in which only one laser head 102 is present, past which the bearing component 2 is rotated. This makes it possible for a continuous region on the bearing component to be heated and thus hardened, depending on the control. Such a bearing component 2 is illustrated, for example, in FIGS. 8 to 10, in which continuous regions were heated and hardened by means of the laser head.

Of course, it is however also possible for the laser head to be controlled in such a way that it only intermittently irradiates the bearing component 2, such that a discontinuous pattern, as illustrated for example in FIG. 11, is produced during the rotation of the bearing component 2 relative to the laser head 102.

In order to irradiate a larger region 20, it is furthermore advantageous to use more than one laser head 102, as in FIGS. 3A, 3B, 4A and 4B, wherein the laser heads 102-1, 102-2 are arranged in such a way that their regions 20-1, 20-2 heated by the respective laser beam are arranged directly adjacent to one another (see FIG. 3B) or are arranged with only a small-scale offset relative to one another (see FIG. 4B).

In the case of directly adjacent regions 20, hardening is thus carried out without slip. If, however, the regions 20-1, 20-2 are not aligned exactly with one another, non-irradiated regions or reheated regions, so-called soft zones in which the bearing component is not hardened, may be formed between the irradiated regions. These soft zones may also be intentionally induced, in order, for example, to apply particular structures to the bearing component.

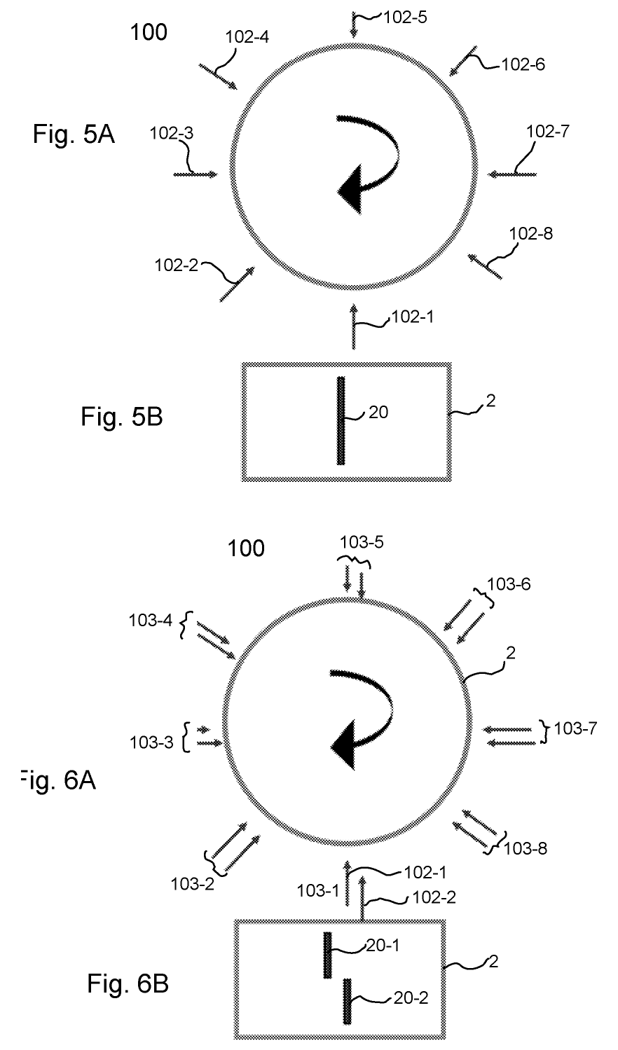

Furthermore, FIGS. 5A and 5B show exemplary embodiments in which a plurality of laser heads 102 are arranged around the bearing component 2. In FIG. 5A, eight laser heads 102-1 to 102-8 are arranged uniformly around the bearing component 2 and each irradiate a single continuous region. Thus, FIG. 5B shows hardening without slip by means of laser heads 102-1 to 102-8 which are distributed uniformly around the circumference and rapid ring rotation through 360° once or multiple times or only through 360°/number of laser heads. As a result of the rapid ring rotation and the large number of laser heads, the entire surface of the bearing ring is heated uniformly and simultaneously, with the result that no soft points can occur.

In FIG. 6A, by contrast, at the same points as in FIG. 5A there is not only one laser head but two laser heads, which in turn irradiate regions with a small-scale offset relative to one another. Thus, FIG. 6B shows hardening without slip by means of laser head pairs 103-1 to 103-8 which are arranged pairwise uniformly around the circumference of the bearing component and the laser beams of which each irradiate different, but adjacent partial regions 20 on the bearing component 2 and rapid ring rotation. As a result of the rapid ring rotation, the large number of laser heads and the adjacent irradiated partial regions, the entire surface of the bearing ring is heated uniformly and simultaneously, with the result that no soft points can occur. Alternatively, the bearing component 2 is only moved rapidly through 360°/number of laser heads in order to prevent slip.

Of course, it is also possible for the laser head/laser heads to be moved, or for the bearing ring and the laser head/laser heads to be moved relative to one another. Such an exemplary embodiment is illustrated in FIGS. 7A and 7B. In this exemplary embodiment, at least one drive apparatus (not illustrated) is in the form of a laser head movement apparatus which is configured to move the laser head 102 along the bearing component 2.

Since laser head power supply devices (not illustrated), in particular, for example, power cables or fibre-optic cables, also have to be moved together with the laser head 102, it is furthermore advantageous if the laser hardening installation 100 has not only one but at least a first 102-1 and a second laser head 102-2, which, as schematically illustrated by the arrows, are moved in opposite directions to one another from a start position I to an end position II along the bearing component 2. In this case, the first laser head 102-1 is moved clockwise and the second laser head 102-2 is moved anticlockwise along the bearing component 2. As a result, the laser heads are moved only through 180° or less along the bearing component 2.

In order to nevertheless carry out hardening in a slip-free manner, that is to say without soft points, it is furthermore advantageous if the first and the second laser head 102-1, 102-2 in the start position I are arranged directly next to one another in a start zone, such that the regions 20-1, 20-2 irradiated by the laser beams of the first and second laser head are directly adjacent to one another in the start zone (see partial view B). The same applies to the end position II, in which the first and the second laser head 102-1, 102-2 in the end position are also arranged directly next to one another, such that the regions 20 irradiated by the laser beams of the first and second laser head 102 are directly adjacent to one another in the end zone.

Since, however, slip sometimes cannot be avoided in the start zone I and end zone II even in the case of regions 20 irradiated with a laser beam which are directly adjacent to one another, a further exemplary embodiment in which a third and/or a fourth laser head, which are designed as pre-heating laser heads, are furthermore provided, which are respectively movable by means of a third and/or a fourth laser head movement apparatus, wherein the third and/or fourth laser head movement apparatuses are configured to move the third and fourth laser head in such a way that a region in the start zone and/or end zone can be heated is advantageous. This also makes it possible to ensure in the start zone and end zone that uniform hardness is obtained on the bearing component.

The laser head movement apparatus may be in the form of a physical movement apparatus that moves the entire laser head, but it is also possible for in particular the third and/or fourth laser head movement apparatus to be in the form of a laser beam deflection apparatus. Since here only a small region of the start and end zone is irradiated, a laser beam deflection apparatus is sufficient to heat the entire start and end zone.

As mentioned above, with the aid of the laser hardening installation 100 and the at least one laser head 102, different hardened regions can be generated on the bearing component 2. Hardening can thus be carried out continuously without slip, continuously with slip and/or discontinuously.

FIGS. 8 to 11 show different embodiments of bearing components 2, in which one or more laser heads 102 have been used to apply different structures with the aid of hardened regions 20 and non-hardened regions 22 and reheated regions 25 to the bearing component 2.

For example, FIG. 8 shows that the laser-hardened region 20 extends over the entire outer surface 8 of the bearing component 2. The surface 20 may be laser-hardened in a slip-free manner, that is to say without any noticeable difference in the hardening of the surface 20 over the entire circumference, or with slip, that is to say with at least one joint 25 (see FIG. 9).

In order to carry out hardening without slip, it is necessary that the laser beam of the at least one laser head strikes the bearing component 2 in such a way that the irradiated regions 20 are directly adjacent to one another and neither already heated regions are heated again nor regions are not irradiated at all.

If hardening is not carried out in a slip-free manner, a soft seam may also be present in the region of the optional joint 25. Such a soft point/soft seam may, for example, be produced by an already hardened region 20 being heated again. This may be effected, for example, by the laser that irradiates the surface to be hardened passing again over regions of the surface to be hardened that have already been heated and cooled down or introducing heat into the regions, for example by heat conduction in the event of a very small distance between the laser and the already hardened surface.

In contrast to FIG. 8, in which the entire outer surface is laser-hardened, FIGS. 9 to 11 show exemplary embodiments in which not the entire outer surface 8 of the bearing component is hardened. For example, FIG. 9 shows a bearing component 2, in which a first surface region 20 is laser-hardened to a first hardness depth T1, a second surface region 22, which is laser-hardened to a second hardness depth T2, and a third surface region 24, which in the illustrated case is not laser-hardened at all, is formed. In addition, FIG. 9 shows that the laser-hardened surface region 20 does not extend around the entire circumference, with the result that a gap 26 remains in an end region/seam region 25.

FIG. 10 shows an exemplary embodiment in which two laser-hardened surface regions 20-1, 20-2 are formed on the outer surface with the aid of one or more laser heads. Laterally and centrally, surface regions 22-1, 22-2, 22-3 with a lower hardness depth T2 and/or non-laser-hardened regions 24-1, 24-2, 24-3 may be formed in each case. These regions 22, 24 may, for example, function as lubricant channels in order to guide lubricant specifically onto the hardened surface.

In addition to the exemplary embodiments that extend in a more continuous manner in FIGS. 8-10, it may also be possible to laser-harden only discrete points, as illustrated, for example, in the exemplary embodiment in FIG. 11. Of course, other patterns are conceivable, such that, for example, specific patterns for the assignment of the bearing ring to a particular manufacturer are also possible.

In summary, the presented laser hardening installation 100 can be used to easily and rapidly harden bearing components without the need for additional quenching apparatuses. This makes it possible to simplify the entire hardening method and the hardening installation. Furthermore, the flexible control of the laser head/heads makes it possible to also provide more unusual, that is to say not only continuously hardened surfaces on the bearing component, but rather a structure which, for example, also allows other functions, such as a lubricant guide, can also be specifically applied. Of course, the presented laser hardening installation can, however, also be used to harden a raceway of a rolling bearing in a conventional manner, in order to provide sufficient resistance to the rolling contact and to increase the service life of the bearing. In particular, the presented laser hardening installation, in particular the heating by the irradiation with the aid of the at least one laser head, can also be used to generate a hardness penetration depth which covers a Hertzian stress produced by the rolling contact when the rolling elements roll over the raceway.

Representative, non-limiting examples of the present invention were described above in detail with reference to the attached drawings. This detailed description is merely intended to teach a person of skill in the art further details for practicing preferred aspects of the present teachings and is not intended to limit the scope of the invention. Furthermore, each of the additional features and teachings disclosed above may be utilized separately or in conjunction with other features and teachings to provide improved laser hardening installations.

Moreover, combinations of features and steps disclosed in the above detailed description may not be necessary to practice the invention in the broadest sense, and are instead taught merely to particularly describe representative examples of the invention. Furthermore, various features of the above-described representative examples, as well as the various independent and dependent claims below, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter.

What is claimed is:

1. A laser hardening installation for laser hardening a bearing component having a closed curve profile, comprising:
a support for supporting the bearing component,
at least one laser head configured to direct a laser beam onto the bearing component to heat a region of the bearing component irradiated by the laser beam to a temperature above an austenitizing temperature of a steel of the bearing component, and
at least one drive apparatus configured to move the bearing component and/or the at least one laser head and/or the laser beam in such a way that the bearing component and the at least one laser head and/or the laser beam move relative to one another, such that different regions of the bearing component are irradiated and heated by the laser beam.

2. The laser hardening installation according to claim 1,
including at least one control device configured to control the laser head, the drive unit and/or a laser beam deflection device in order to direct the laser beam into the region irradiated by the laser beam.

3. The laser hardening installation according to claim 2,
wherein the laser head is configured to generate a laser beam which heats a strip-shaped region of the bearing component.

4. The laser hardening installation according to claim 2,
wherein the laser head includes a diode laser.

5. The laser hardening installation according to claim 2,
wherein the at least one laser head comprises a plurality of laser heads arranged to irradiate a plurality of directly adjacent regions of the bearing component.

6. The laser hardening installation according to claim 2,
wherein the plurality of laser heads are arranged uniformly around the bearing component.

7. The laser hardening installation according to claim 2,
wherein the at least one laser head comprises a plurality of laser heads arranged to irradiate a plurality of overlapping regions of the bearing component.

8. The laser hardening installation according to claim 2,
wherein the at least one drive apparatus is configured to rotate the bearing component.

9. The laser hardening installation according to claim 8,
wherein the at least one drive includes at least three discrete support units, and
wherein at least one of the support units comprises the drive unit.

10. The laser hardening installation according to claim 9,
wherein the drive unit comprises a rotatable friction wheel or friction roller configured to bear against the bearing component and frictionally engage the bearing component.

11. The laser hardening installation according to claim 2,
wherein the at least one drive apparatus comprises a laser head movement apparatus configured to move the laser head along the bearing component.

12. The laser hardening installation according to claim 11,
wherein the at least one laser head comprises a first laser head and a second laser head movable respectively by a first and a second laser head movement apparatus,
wherein the first and a second laser head movement apparatuses are configured to move the first and the second laser heads in opposite directions to one another from a start position to an end position along the bearing component, and
wherein the first laser head is movable clockwise and the second laser head is movable anticlockwise along the bearing component.

13. The laser hardening installation according to claim 12,
wherein the first and second laser heads in the start position are arranged directly next to one another in a start zone such that the regions irradiated by laser beams of the first and second laser heads are directly adjacent to one another in the start zone, and/or
wherein the first and second laser heads in the end position are arranged directly next to one another in an end zone, such that the regions irradiated by the laser beams of the first and second laser head are directly adjacent to one another in the end zone.

14. The laser hardening installation according to claim 12,
including at least a third laser head configured as a pre-heating laser head and movable by a third laser head movement apparatus,
wherein the third laser head movement apparatus is configured to move the third laser head in such a way that a region in the start zone and/or end zone is heated.

15. The laser hardening installation according to claim 14,
wherein the third laser head movement apparatus is a laser beam deflector.

16. The laser hardening installation according to claim 2,
wherein the at least one drive apparatus comprise a laser beam deflector configured to move the laser beam over a surface of the bearing component.
